(19) United States
(12) Patent Application Publication
(10) Pub. No.: US 2013/0012845 A1
(43) Pub. Date: Jan. 10, 2013

(54) KNEE JOINT MOBILIZER

(76) Inventor: Joseph Swoyer, Hatboro, PA (US)

(21) Appl. No.: 13/543,813

(22) Filed: Jul. 7, 2012

Related U.S. Application Data
(60) Provisional application No. 61/505,351, filed on Jul. 7, 2011.

(51) Int. Cl. A61H 1/02

(52) U.S. Cl. 601/5

(57) ABSTRACT

An apparatus for applying a periodic motion to a limb includes a base, a chassis including a motor for providing rotational motion, a platform for receiving a limb slideably secured to the chassis, and a drive for providing linear oscillatory motion to the platform.

### CROSS-REFERENCE TO RELATED APPLICATION

This application claims priority from U.S. Patent Application No. 61/505,351, filed Jul. 7, 2011.

### BACKGROUND OF THE INVENTION

1. Field of the Invention

The present invention relates to an apparatus for mobilizing the knee of a subject, and to the therapeutic use of such apparatus for physical therapy rehabilitation.

2. Brief Description of the Prior Art

Post-operative knee surgery patients, and in particular post-operative knee replacement surgery patients and individuals with arthritic knee pain, can frequently benefit from mobilization of the affected knee joints. While such mobilization can be effectively applied by a physical therapist using hands-on manipulation, there is a need for a mechanical mobilization device that recovering patients can use at home or elsewhere to supplement individual physical therapy sessions with trained professional therapists.

Body mobilization devices are known in the art. For example, U.S. Patent Publication 2011/0196270 A1 discloses an apparatus for mobilization of the body with the subject in a standing position to provide rehabilitation, particularly of the shoulder, knee, hip and spinal column. U.S. Patent Publication 2009/0137369 A1 discloses an orthotic apparatus for providing an improved range of motion for a human limb, and in particular, for legs. U.S. Patent Publication 2010/0204620 A1 discloses a therapy and mobility assistance system used by a patient that includes a leg device that provides assistance and/or resistance to enhance the mobility of the leg. U.S. Patent Publication 2009/0163837 A1 discloses a knee flexion device designed to exercise and flex the tissue around an artificial knee following knee replacement surgery. U.S. Patent Publication 2011/0003666 A1 disclosed an apparatus for aerobic leg exercise for a seated user. U.S. Patent Publication 2009/0017995 A1 discloses a knee manipulating device for a seated user for exercising and manipulating a knee after reconstructive knee surgery. U.S. Patent Publication 2012/0078142 A1 discloses a continuous passive motion device for flexing and extending a patient's knee. U.S. Patent Publication 2008/0051682 A1 discloses a continuous passive motion device for providing oscillatory motion to a patient's foot. Given the increasing number of patients with arthritic knees, knee injuries, and surgical knee replacements, there is a continuing and growing need for effective, efficient, low-cost rehabilitation devices and treatment methods for such patients.

### SUMMARY OF THE INVENTION

The present invention provides an apparatus for applying a periodic motion to the joint of a limb, and in particular to the knee of a human patient, and a method of using the apparatus to mobilize the knee. The apparatus comprises a base and a chassis positioned above the base and secured to the base. The chassis includes a motor for providing rotational motion. The apparatus further includes a platform for receiving a limb positioned above the chassis. The platform is slideably secured to the chassis. The apparatus further includes a drive extending from the chassis to the platform for converting the rotational motion of the motor to provide linear oscillatory motion to the platform. Preferably, the apparatus further includes a pivot mechanism for rotating the chassis about an axis with respect to the base. The axis lies in a plane parallel to the support member. Further, a releasable locking mechanism for locking the platform at a predetermined angle with respect to the horizontal is preferably provided. Preferably, the apparatus further includes at least one guide member extending between the chassis and the platform for guiding the oscillatory motion of the platform. Preferably, the platform includes an aperture for receiving the at least one guide member. Preferably, the at least one guide member extends through the aperture. Preferably, the apparatus further includes at least one lock member positioned on said at least one guide member below the platform. In this aspect, the at least one lock member is slideable on, and lockable to, the at least one guide member. Preferably, the platform includes an upper plate and a lower plate. Preferably, the upper plate extends parallel to the lower plate at a predetermined distance above the lower plate. Preferably, the upper plate has a general hour-glass shape for receiving a lower limb, with the knee of the lower limb being positioned above the upper plate, The general hourglass shape is adapted to receive the calf and hamstring mass of the limb. In one presently preferred embodiment, the drive includes a cam member. Preferably, the shape of the cam is adapted to provide a predetermined oscillatory movement to the platform. Preferably, the period of the oscillatory movement is adjustable. Preferably, the speed of the motor is adjustable. Preferably, the apparatus also includes a remote control for adjusting the speed of the motor. Preferably, the platform includes a pad for cushioning a limb positioned on the apparatus.

### BRIEF DESCRIPTION OF THE DRAWINGS

FIG. 1 is a left side elevational view of a presently preferred embodiment of a knee mobilization apparatus of the present invention showing the platform in a lowered position, and the chassis parallel to and on top of the base of the apparatus.

FIG. 2. is a right side elevational view of the knee mobilization apparatus of FIG. 2 showing the platform in an elevated position.

FIG. 3. is a left side elevational view of the knee mobilization apparatus of FIG. 1 showing the platform in a lowered position and the chassis inclined at an angle from the base of the apparatus.

FIG. 4 is a front elevational view of the knee mobilization apparatus of FIG. 1.

FIG. 5. is a top plan view of the knee mobilization apparatus of FIG. 1.

### DETAILED DESCRIPTION

The present invention provides a knee joint mobilizer apparatus which a human patient can employ to relieve knee pain, reduce adhesion formation, and increase range of motion (ROM) secondary to post-surgery tightness/adhesion formation, or post trauma to the joint.

The knee joint mobilizer of the present invention provides an oscillation that mobilizes the human knee joint mechanically. The knee joint mobilizer complements physical therapist's manual treatment of hands-on mobilization. The knee joint mobilizer provides patients with the ability to take the manual mobilization capability with them to their homes using a mechanical unit.

Joint mobilizations have been shown to relieve pain and improve range of motion (ROM) of injured joints.

As set forth in the present specification, the grades of mobilization reflect the classification of Maitland. Maitland GD. Peripheral Manipulation. London, UK: Butterworths, 1978.

The knee joint mobilization apparatus of the present invention is intended to be used under the supervision of a profession physical therapist, because the set-up and use of the apparatus should be directed by the therapeutic needs and goals of the individual patient, following a professional evaluation of the patient.

The knee joint mobilization apparatus of the present invention should prove valuable to post-operative knee surgery patients, in particular, post-operative knee replacement surgery. Further, the apparatus can also be used for individuals with arthritic knee pain.

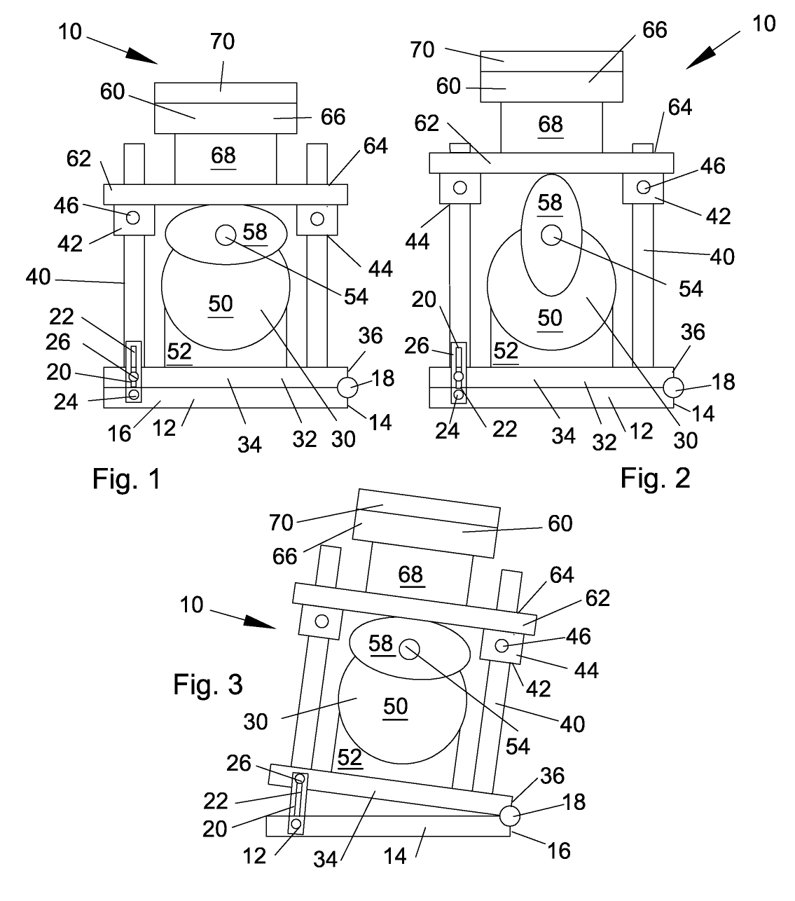

Referring now to the figures in which like reference numerals represent like elements in each of the several views, there is shown in FIG. 1 a left side elevational view of a present preferred embodiment of an apparatus 10 of the present invention for applying a periodic motion to the joint of a limb, and in particular to the knee of a human patient (not shown). The apparatus 10 includes a generally rectangular base 12 preferably formed from metal, such as a metal casting, to provide a secure foundation to the apparatus 10 and help to provide a low center of gravity, and having a pair of parallel edges 14 and a pair of parallel sides 16. The apparatus 10 also includes a chassis 30 positioned immediately above the base 12. The chassis includes a generally rectangular lower or base plate 32, the base plate 32 of the chassis 30 being generally coextensive with the base 12 of the apparatus 10. The base plate 32 has a pair of parallel edges 32 and a pair of parallel sides 34. The base 12 and the base plate 32 of the chassis 30 are pivotally joined along one side of the base 16 and a corresponding side 36 of the base plate 32 by a hinge or pivot mechanism 18 adapted so that the chassis 30 can be rotated up and away from the base 12 up through an angle extending from zero to about 20 degrees, as shown in FIG. 3. A lock plate 20 provided with a slot 22 extends between the base 12 and the base plate 32 at one of the edges 14 of the base 12 and one of the edges 34 of the base plate 32 proximate the sides 16, 36 opposite the sides 16, 36 upon which the hinge 18 is mounted. The lock plate 20 is rotatably fixed to the base 12 with a pivot 24. A lock screw 26 is mounted through the slot 22 of the lock plate 20 to the edge 34 of the base plate to secure the chassis 30 at the angle of inclination relative to the base 12 desired by the patient employing the apparatus 10. Preferably, the angle of inclination is selected for the comfort of the patient and to achieve a desired angle of oscillation.

The chassis 30 also includes four guide members or rods 40 extending upward from and perpendicular to the upper surface of the base plate 32 of the chassis 30 proximate the corners of the base plate 32. The guide members 40 are each provided with a respective generally cylindrical lock member 42 which slideably receives the respective guide member 40 within an internal aperture or bore 44. Each of the lock members 42 is also provided with a thumb screw 46 for locking the lock member 42 in a predetermined position on the respective guide member 40.

The chassis 30 is also provided with a motor 50 mounted on a base 52 secured to the lower plate 32 of the chassis 50. The motor 50 is provided with a drive 54 including a drive shaft 56 upon which is fixedly mounted a cam 58 having a generally elliptical shape. The motor 50 may also include suitable reduction gears (not shown) for reducing the rate of rotation of the motor 50 as applied to the drive shaft 56 and cam 58.

The apparatus 10 also includes a platform 60 positioned above the chassis 30. The platform includes a generally rectangular lower plate 62 having approximately the same general dimensions as the lower plate 32 of the chassis 30. The lower plate 62 of the platform 60 includes a plurality of apertures or bores 64 positioned proximate the four corners of the lower plate 62 of the platform 60 through which the guide members or rods 40 extend. The surface of the cam 58 contacts the underside of the lower plate 62 of the platform 60 such that as the cam 58 rotates with the drive shaft 56 of the chassis 30, a linear oscillatory, up-and-down motion is imparted to the platform 60. The stroke of the linear oscillatory motion can be varied by adjusting the position of the lock members 42 along the guide members 40. As shown in FIGS. 1, 3 and 4, when the lock members 42 are located such that their upper surfaces lie in a common plane with the cam 58 parallel the long axis of the cam 58, the length of the stroke is maximized. Conversely, when the lock members 42 are located such that their upper surfaces lie in a common plane with the cam 58 and perpendicular to the long axis of the cam 58, the stroke is negligible. Each lock member 42 can be mounted at any place along the respective guide member 40 so as to achieve a stroke intermediate between a maximum stroke and zero stroke, according to the plan of therapy selected by the therapist.

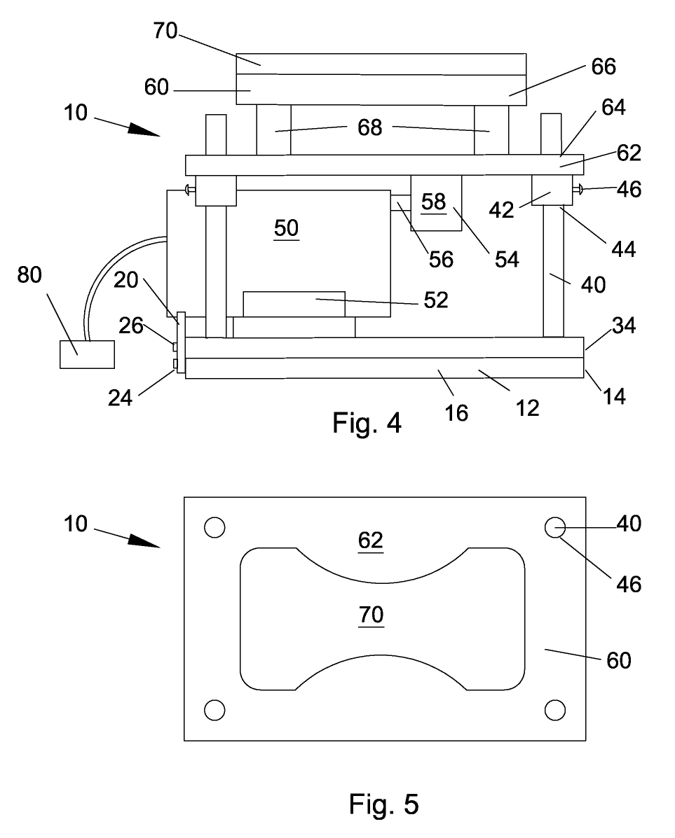

The platform 60 also includes an upper plate 66 preferably formed from a rigid material such as aluminum, and having a generally hourglass shape, as can be seen in the top plan view of FIG. 5. The hourglass shape is adapted to comfortably receive the leg of a patient, with the leg extending perpendicular to the long axis of the apparatus 10 and centered approximately on the short axis of the apparatus 10 (not shown). The pair of support members 68, best seen in the side elevational view of FIG. 4, extend between the lower plate 62 and upper plate 66 of the platform 60 to support the upper plate 66. The upper plate 66 is preferably covered with a pad 70 formed from a soft foam material covered with a washable fabric for the comfort of the patient. This foam pad 70 is preferably contoured to the shape of the human leg (behind the knee at the tibial-femoral junction/joint). The platform 60 or upper plate 66 is preferably provided in different sizes to better fit the leg of the patient, and can be custom-made to fit an individual patient.

The rotational speed of the motor 80 is controlled with a remote control 80 adapted to be grasped by the patient. The remote control 80 is configured to provide the patient/user with full control over the apparatus 10. The remote control 50 is preferably programmed to enable the user to execute predetermined modes as described below. Further, the remote control is 80 preferably adapted to plug into the side of the apparatus 10, but may in the alternative be provided with wireless functionality to connect to and control the apparatus 10, and is preferably adapted to be charged when the apparatus 10 is supplied with common household electrical current. The remote control 890 is preferably provided with a screen to display battery life of the remote control 80, the preprogrammed, predetermined modes of operation, and the frequency and the time and duration of each session. The recommended use of the apparatus is 10-15 minutes for each session.

The apparatus of the present invention can be used in a number of different modes, depending on the individual needs and goals of the patient as determined by the physical therapist. For example, in an initial mode of use (Grade 1, at beginning range of knee joint movement) the apparatus can be set to provide 60-120 events (rotations) per minute, with one mm of linear distance. Other modes that can be employed include a second mode (Grade 2, larger range of knee joint movement), the apparatus can be set to provide 60-120 events per minute, with 2 mm of distance. In a third mode that can be used (Grade 3, even larger range of knee joint movement), the apparatus can be set to provide 60-120 events per minute, with 3 mm of distance.

Various modifications can be made in the details of the various embodiments of the apparatus and method of the present invention, all within the scope and spirit of the invention and defined by the appended claims

1. An apparatus for applying a periodic motion to a limb, the apparatus comprising:
a base;
a chassis positioned above the base and secured to the base, the chassis including a motor for providing rotational motion;
a platform for receiving a limb positioned above the chassis and slideably secured to the chassis;
a drive extending from the chassis to the platform for converting the rotational motion of the motor to provide linear oscillatory motion to the platform.

2. An apparatus according to claim 1 further comprising a pivot mechanism for rotating the chassis about an axis with respect to the base, the axis lying in a plane parallel to the support member, and a releasable locking mechanism for locking the platform at a predetermined angle with respect to the horizontal.

3. An apparatus according to claim 1 further comprising at least one guide member extending between the chassis and the platform for guiding the oscillatory motion of the platform.

4. An apparatus according to claim 3 wherein the platform includes an aperture for receiving the at least one guide member, the at least one guide member extending through the aperture.

5. An apparatus according to claim 3 further comprising at least one lock member positioned on said at least one guide member below the platform, the at least one lock member being slideable on and lockable to said at least one guide member.

6. An apparatus according to claim 1 wherein the platform includes an upper plate and a lower plate, the upper plate extending parallel to the lower plate a predetermined distance above the lower plate.

7. An apparatus according to claim 6 wherein the upper plate has a general hour-glass shape for receiving a lower limb, with the knee of the lower limb being positioned above the upper plate, the general hourglass shape being adapted to receive the calf and hamstring mass of the limb.

8. An apparatus according to claim 1 wherein the drive includes a cam member.

9. An apparatus according to claim 8 wherein the shape of the cam is adapted to provide a predetermined oscillatory movement to the platform.

10. An apparatus according to claim 1 wherein the period of the oscillatory movement is adjustable.

11. An apparatus according to claim 10 wherein the speed of the motor is adjustable.

12. An apparatus according to claim 11 further including a remote control for adjusting the speed of the motor.

13. An apparatus according to claim 1 wherein the platform includes a pad for cushioning a limb positioned on the apparatus.
